(19) United States
(12) Patent Application Publication
(10) Pub. No.: US 2024/0403010 A1
(43) Pub. Date: Dec. 5, 2024

(54) CODE CONVERSION DEVICE, METHOD AND PROGRAM

(71) Applicant: NEC Corporation, Tokyo (JP)

(72) Inventor: Masashi KOTERA, Tokyo (JP)

(73) Assignee: NEC Corporation, Tokyo (JP)

(21) Appl. No.: 18/668,454

(22) Filed: May 20, 2024

(30) Foreign Application Priority Data
Jun. 1, 2023 (JP) 2023-090583

(51) Int. Cl. G06F 8/41

(52) U.S. Cl. CPC G06F 8/443

(57) ABSTRACT

The input means accepts input of a target program code which is the program code to be processed. The extraction means extracts, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing. The conversion means converts the extracted first program code and second program code into alternative program code, which is program code indicating a process that does not make a function call that invokes the predefined processing by the function and that produces a same result as the processing by the first program code and the second program code.

### CROSS-REFERENCE TO RELATED APPLICATIONS

This application is based upon and claims the benefit of priority from the prior Japanese Patent Application No. 2023-090583, filed Jun. 1, 2023, the entire contents of which are incorporated herein by reference.

### BACKGROUND OF THE INVENTION

This disclosure relates to a code conversion device, a code conversion method, and a code conversion program for converting codes used by a computer for processing.

To efficiently use data stored in databases, program codes are generally defined and processing is performed based on the defined codes. In recent years, the demand and market for analyzing large data has been growing, and in order to analyze large data at high speed, it is necessary to create programs with high speed in mind.

For example, Patent Literature 1 describes a system for sequentially performing data processing by analyzing a data processing program created by a defined script. The system described in Patent Literature 1, when analyzing a script, converts or complements the arguments of application program interface (API) functions to match the arguments of the original API functions in a library.
[Patent Literature 1] Japanese Patent Application Publication No. 2017-120611

### SUMMARY OF THE INVENTION

By using the system described in Patent Document 1, it is possible to create programs from scripts that can perform data processing. However, the system described in Patent Document 1 does not consider the time required for data processing.

As the number of data to be processed increases, the time required for processing is also expected to increase. Therefore, it is desirable to be able to convert existing codes into codes that produce similar results so that data processing time can be reduced.

Therefore, it is an exemplary object of the present disclosure to provide a code conversion device, a code conversion method, and a code conversion program that can convert existing codes into codes that produce same results so that data processing time can be reduced.

The code conversion device according to the present disclosure includes an input means which accepts input of a target program code which is the program code to be processed, an extraction means which extracts, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing, a conversion means which converts the extracted first program code and second program code into alternative program code, which is program code indicating a process that does not make a function call that invokes the predefined processing by the function and that produces a same result as the processing by the first program code and the second program code, and an output means which outputs the alternative program code.

The code conversion method according to the present disclosure includes: accepting input of a target program code which is the program code to be processed; extracting, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing; converting the extracted first program code and second program code into alternative program code, which is program code indicating a process that does not make a function call that invokes the predefined processing by the function and that produces a same result as the process by the first program code and the second program code; and outputting the alternative program code.

The code conversion program according to the present disclosure for causing a computer to execute: input process of accepting input of a target program code which is the program code to be processed; extraction process of extracting, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing; conversion process of converting the extracted first program code and second program code into alternative program code, which is program code indicating a process that does not make a function call that invokes the predefined processing by the function and that produces a same result as the process by the first program code and the second program code; and output process of outputting the alternative program code.

According to this disclosure, existing codes can be converted into codes with same results so that processing time for data can be reduced.

### BRIEF DESCRIPTION OF DRAWINGS

FIG. 1 is a block diagram showing a configuration example of an example embodiment of the code conversion device.

FIG. 2 is an explanatory diagram showing an example of aggregation processing.

FIG. 3 is an explanatory diagram showing an example of code correspondence.

FIG. 4 is a flowchart showing an example of an operation of the code conversion device.

FIG. 5 is a flowchart showing an example of an operation of extraction processing.

FIG. 6 is a flowchart showing an example of an operation of extraction processing.

FIG. 7 is a flowchart showing an example of an operation of conversion processing.

FIG. 8 is a flowchart showing an example of an operation of conversion processing.

FIG. 9 is an explanatory diagram showing an example of extraction processing and conversion processing.

FIG. 10 is an explanatory diagram showing a first example of conversion processing.

FIG. 11 is an explanatory diagram showing a first example of conversion processing.

FIG. 12 is an explanatory diagram showing a second example of conversion processing.

FIG. 13 is an explanatory diagram showing a second example of conversion processing.

FIG. 14 is an explanatory diagram showing a third example of conversion processing.

FIG. 15 is an explanatory diagram showing a third example of conversion processing.

FIG. 16 is an explanatory diagram showing a fourth example of conversion processing.

FIG. 17 is an explanatory diagram showing a fourth example of conversion processing.

FIG. 18 is a block diagram showing an overview of the code conversion device according

### DETAILED DESCRIPTION OF THE INVENTION

The following is a description of an example embodiment of the present disclosure with reference to the drawings. The following describes a case in which data represented in a two-dimensional tabular format is processed. An example of data represented in such a format is a data frame. In the following description, data in a two-dimensional tabular format is sometimes referred to as a data frame.

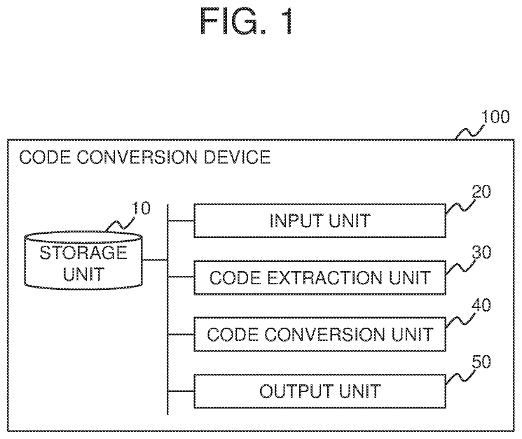

FIG. 1 is a block diagram showing a configuration example of an example embodiment of the code conversion device according to the present disclosure. The code conversion device 100 according to this example embodiment includes a storage unit 10, an input unit 20, a code extraction unit 30, a code conversion unit 40, and an output unit 50.

The storage unit 10 stores various information used by the code conversion device 100 in performing processing. The storage unit 10 may also store information received by the input unit 20 (described below) and the results of processing by the code conversion unit 40. The storage unit 10 is realized by, for example, a magnetic disk.

The input unit 20 accepts input of the program code to be processed (hereinafter referred to as “target program code”). For example, the input unit 20 may retrieve the target program code from the storage unit 10 or from an external storage server (not shown). The input unit 20 may also accept input of the target program code from the user via a user interface.

In the following description, Python is shown as an example programming language, and Pandas is shown as a library used to describe the target program code. However, the target program code need not be written based on Pandas, and any programming language other than Python can be used. The code extraction unit 30 and the code conversion unit 40 described below may perform processing according to the rules of the used target program code.

The code extraction unit 30 extracts a program code that can be converted into codes that can reduce the processing time for data frames from the input target program codes. Specifically, the code extraction unit 30 extracts a program code (hereinafter referred to as first program code) that indicates that aggregate processing of each column in a data frame is performed based on a value of a predetermined column for data in a two-dimensional tabular format (i.e., a data frame). In the case of Pandas, an example of an aggregate processing extracted as a first program code is the groupby( ) method.

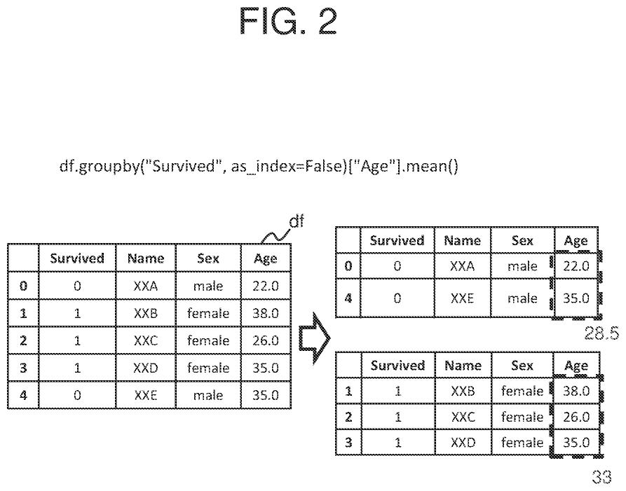

FIG. 2 an explanatory diagram showing an example of aggregation processing. FIG. 2 shows an example of the process of calculating the average age for the data in data frame df by dividing those who survived and those who died into groups.

Furthermore, the code extraction unit 30 extracts from the input target program code a program code that indicates predefined processing to be performed on each data frame for which the aforementioned aggregation processing is performed and a function that calls that processing (hereinafter referred to as the second program code). In the case of Pandas, an example of a function extracted as the second program code is the apply( ) method, and an external function (user-defined function) is included as a predefined process.

The code conversion unit 40 converts the extracted codes (more specifically, the first and second program codes) into codes that can reduce the processing time for the data frame. Note that the conversion of codes here includes not only the conversion of the extracted codes themselves, but also the conversion of other codes that become necessary due to the conversion (and are affected by the conversion).

Specifically, the code conversion unit 40 converts the extracted codes into a program code (hereinafter, alternative program code) that does not make a function call that invokes processing by the extracted function and that indicates processing that produces the same results as processing by the extracted code. In other words, the code conversion unit 40 converts the target program code so that the processing for the aggregated processed data frame can be realized by a processing that does not call a function of an external function.

The code conversion unit 40 may generate the alternative program code by converting a program code contained in the function indicated by the second program code into a corresponding predetermined program code. In this case, a correspondence between a code that can reduce processing time (post-conversion code) and a code that can be converted to that code (pre-conversion code) may be stored in the storage unit 10 in advance, and the code conversion unit 40 may read that correspondence and perform the conversion processing.

It is preferable for the code conversion unit 40 to convert the first and second program codes into the alternative program code when a type of arguments of the function and a type of a return value of the function are identical. This ensures that the program codes are converted into processing that produces same results. An example of a type match is, for example, when both arguments are of type data frame.

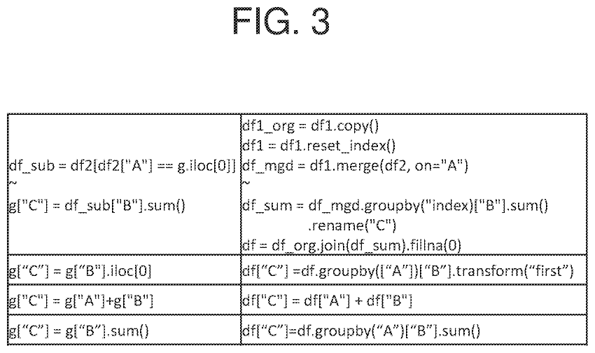

FIG. 3 is an explanatory diagram showing an example of code correspondence. FIG. 3 shows an example of the correspondence used in the case of Pandas. For example, in the second line of the correspondence table shown in FIG. 3, a code (df [“C”]=df.groupby([“A”][“B”]. transform (“first”) that can reduce processing time is associated with the process (g[“C”]=g [“B”]+iloc[0]), which overwrites the values of other elements with the values of the elements in the first line of the aggregated data frame.

For example, in the case of Pandas as shown above, the target program code assumes that a function call using the apply( ) method invokes the external function func( ) and that the external function executes the processing of the data frame aggregated by the groupby( ) method.

In this case, the code conversion unit 40 converts the processing of calling the external function func( ) using the apply( ) method into a program code to obtain the same result without calling the external function func( ).

Since processing by the alternative program code converted in this way suppresses processing that makes function calls, processing time for data can be reduced even for program codes that produce same results. Specific processing using the correspondence shown in FIG. 3 is described later.

The output unit 50 outputs the alternative program code. The output unit 50 may display the alternative program code on a display device (not shown) or may store the alternative program code in the storage unit 10. The output unit 50 may also transmit the code to a device (not shown) that executes the alternative program code.

The input unit 20, the code extraction unit 30, the code conversion unit 40, and the output unit 50 are realized by a computer processor (e.g., CPU (Central Processing Unit), GPU (Graphics Processing Unit (GPU)) that operates according to a program (code conversion program).

For example, the program may be stored in the storage unit 10 of the code conversion device 100, and the processor may read the program and operate as the input unit 20, the code extraction unit 30, the code conversion unit 40, and the output unit 50 according to the program. The functions of the code conversion device 100 may be provided in a Saas (Software as a Service) format.

The input unit 20, the code extraction unit 30, the code conversion unit 40, and the output unit 50 may each be realized by dedicated hardware. Also, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the components of the code conversion device 100 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

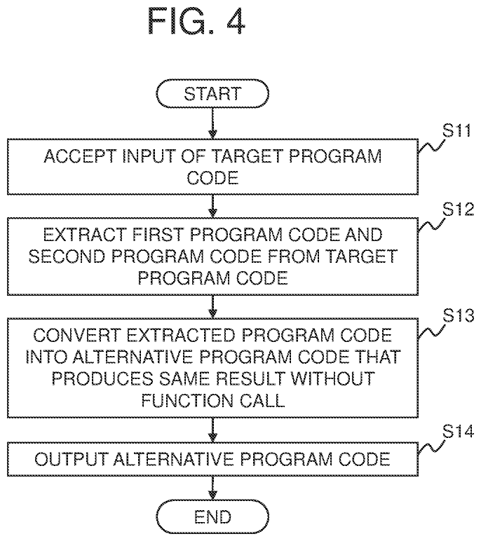

Next, the operation of this example embodiment of the code conversion device 100 will be described. FIG. 4 is a flowchart showing an example of an operation of the code conversion device 100 of this example embodiment. The input unit 20 accepts input of the target program code (step S11). The code extraction unit 30 extracts from the target program code a first program code indicating that the aggregation processing is to be performed, and a second program code indicating the processing to be performed on the data frame for which the aggregation processing is performed and the function that calls the processing (step S12).

The code conversion unit 40 converts the extracted program codes into an alternative program code that produces same results without function calls (step S13). The output unit 50 then outputs the alternative program code (step S14).

Next, specific examples of the processing performed by the code extraction unit 30 is explained. In the following description, a specific example using Pandas described above is described. In addition, in the following description, an operation of referencing and overwriting with an iloc property, an arithmetic operation, and an aggregation operation are exemplified as the target codes to be extracted by the code extraction unit 30 in accordance with the correspondence table shown in FIG. 3. However, the codes to be extracted are not limited to these codes. Any processing that does not involve a function call and for which a conversion process that produces a same result can be defined in the correspondence table can be the target of extraction.

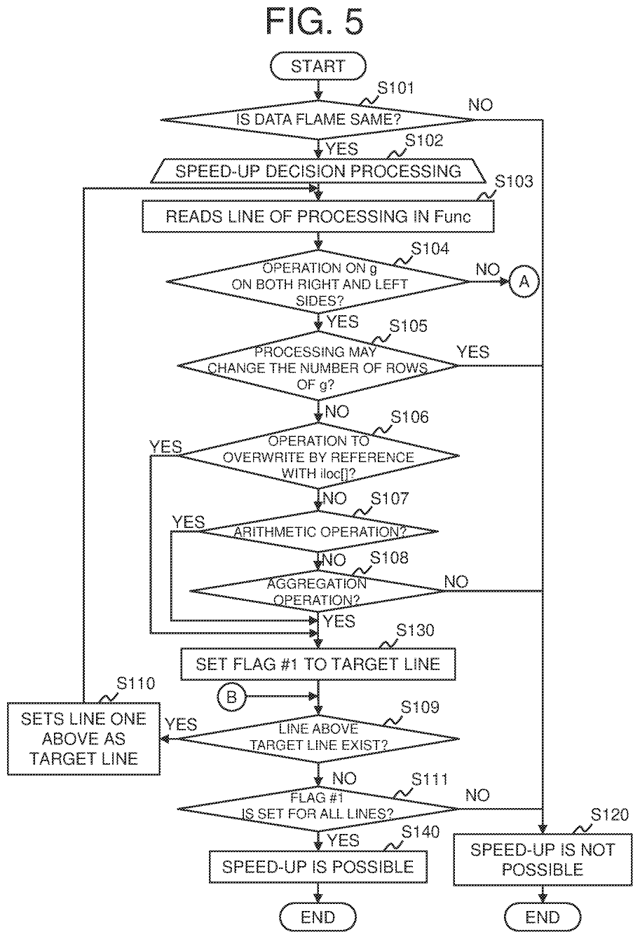

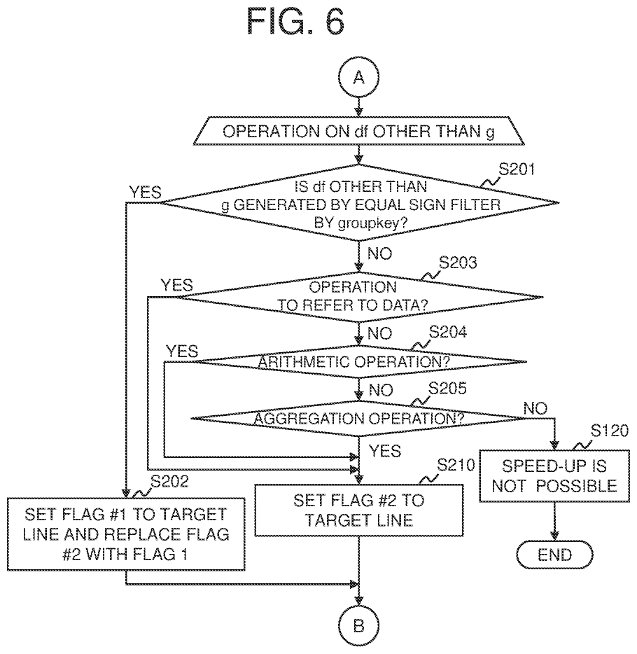

FIGS. 5 and 6 are flowcharts showing an example of an operation of extraction processing by the code extraction unit 30. Here, the function in the target program code is denoted Func, and the data frame that is the argument of the function call is denoted g.

First, the code extraction unit 30 searches for the function Func to be called and determines whether the data frame returned (return) by the function is the same as the data frame input (i.e., argument) to the function (step S101 in FIG. 5). If it is the same (YES in step S101), the code extraction unit 30 performs a processing to determine if speed-up is possible for that function. At that time, the code extraction unit 30 performs the check processing sequentially from the bottom line in the function (step S102). On the other hand, if they are not the same, the code extraction unit 30 determines that speed-up is not possible for that function and terminates the process (Step S120).

The code extraction unit 30 reads a line of processing in the function Func (step S103). The code extraction unit 30 determines whether the operation in the line read (hereinafter referred to as “target line”) is an operation for g on both the right and left sides (Step S104). If both the right side and the left side are operations for g (YES in step S104), the code extraction unit 30 determines whether those operations may change the number of lines of g (step S105).

If there is a possibility of changing the number of lines of g (YES in step S105), the code extraction unit 30 determines that speed-up is not possible and terminates the processing (step S120). On the other hand, if there is no possibility of changing the number of lines of g (NO in step S105), the code extraction unit 30 determines whether or not the operation of the target line is an operation to overwrite by reference with the iloc property (hereinafter referred to as the first operation). (Step S106). If the operation of the target line is the first operation (YES in step S106), the code extraction unit 30 sets flag #1 to the target line (step S130).

Similarly, if the operation of the target line is not the first operation (NO in step S106) and is an arithmetic operation (YES in step S107), the code extraction unit 30 sets flag #1 to the target line (step S130). Furthermore, if the operation of the target line is not an arithmetic operation (NO in step S107) and is an aggregation operation (YES in step S108), the code extraction unit 30 sets flag #1 on the target line (step S130). If the operation of the target line is not an aggregate operation (NO in step S108), the code extraction unit 30 determines that speed-up is not possible and terminates the processing (step S120). The order of processing from step S106 to step S108 may be interchanged, respectively.

In step S130 after setting flag #1 to the target line, the code extraction unit 30 determines whether a line above the target line (i.e., the previous process) exists (step S109). If a line above the target line exists (YES in step S109), the code extraction unit 30 sets the line one above as the target line (step S110) and repeats the processing from step S103 onward, reading one line of processing in the function Func.

On the other hand, if there is no line above the target line (NO in step S109), the code extraction unit 30 determines whether flag #1 is set in all lines in the function Func (step S111). If flag #1 is not set in all lines (NO in step S111), the code extraction unit 30 determines that speed-up is not possible and terminates the processing (step S120). On the other hand, if flag #1 is set for all lines (YES in step S111), the code extraction unit 30 determines that speed-up is possible (step S140).

If, in step S104, the operation is not for g on both the right and left sides (NO in step S104), that is, if the operation is for a data frame df other than g, then step S201 and subsequent processing are performed as shown in FIG. 6.

Specifically, the code extraction unit 30 determines whether a data frame df other than g is generated by an equal sign filter by a key to be aggregated (groupkey) (step S201). If a data frame df other than g is generated (YES in step S201), the code extraction unit 30 sets flag #1 to the target line and replaces the flag of the line in which flag #2 is set with flag #1 (step S202). Thereafter, the processing from step S109 in FIG. 5 is performed.

On the other hand, if no data frame df other than g is generated (NO in step S201), the code extraction unit 30 determines whether the operation of the target line is an operation to refer to data (hereinafter referred to as the second operation). (Step S203). If the operation of the target line is the second operation (YES in step S203), the code extraction unit 30 sets flag #2 to the target line (step S210).

Similarly, if the operation of the target line is not a second operation (NO in step S203) and is an arithmetic operation (YES in step S204), the code extraction unit 30 sets flag #2 to the target line (step S210). Furthermore, if the operation of the target line is not an arithmetic operation (NO in step S204) and is an aggregation operation (YES in step S205), the code extraction unit 30 sets flag #2 on the target line (step S210). If the operation of the target line is not an aggregate operation (NO in step S205), the code extraction unit 30 determines that speed-up is not possible (step S120) and terminates the processing. The order of processing from step S203 to step S205 may be interchanged, respectively.

Note that after flag #2 is set to the target line in step S210, the processing after step S109 in FIG. 5 is performed.

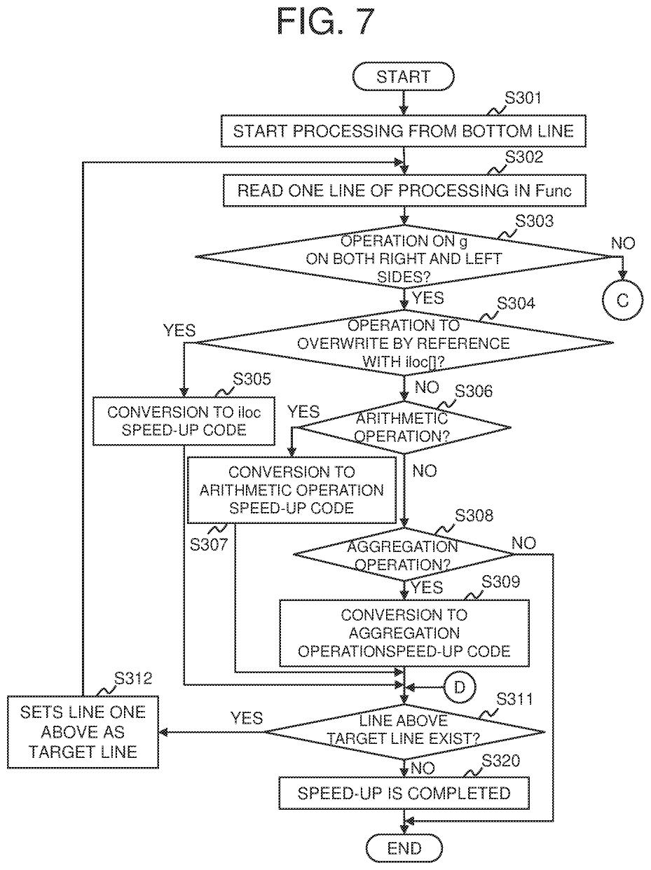

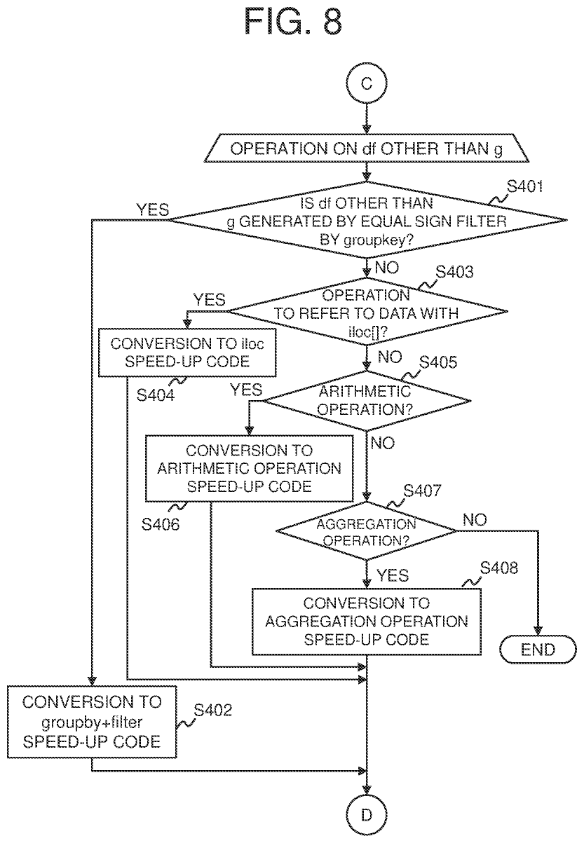

Next, specific examples of the processing performed by the code conversion unit 40 are described. FIGS. 7 and 8 are flowcharts showing an example of an operation of conversion processing by the code conversion unit 40. Here, it is assumed that the extraction processing shown in FIGS. 5 and 6 is performed, and the conversion processing is performed on the target line that is determined to be capable of speed-up. The code conversion unit 40 starts processing from the bottom line in the target function (step S301).

The code conversion unit 40 reads a line of processing in the function Func (step S302). The code conversion unit 40 determines whether the operation in the line read (i.e., the target line) is an operation on g on both the right and left sides (Step S303). If both the right and left sides are operations on g (YES in step S303), the code conversion unit 40 determines whether or not the operation of the target line is an operation to overwrite by reference with the iloc property (i.e., a first operation) (step S304). If the operation of the target line is the first operation (YES in step S304), the code conversion unit 40 converts the code of the target line to a code for speed-up (step S305).

Similarly, if the operation of the target line is not the first operation (NO in step S304) and is an arithmetic operation (YES in step S306), the code conversion unit 40 converts the code of that target line to a code for speed-up (step S307). Furthermore, if the operation of the target line is not an arithmetic operation (NO in step S306), but an aggregation operation (YES in step S308), the code conversion unit 40 converts the code of the target line to a code for speed-up (step S309). If the operation of the target line is not an aggregation operation (NO in step S308), the code conversion unit 40 terminates the processing without converting the code. In the processing from step S304 to step S309, the order of the determination processing may be interchanged.

In step S311 after the code is converted, the code conversion unit 40 determines whether a line above the target line (i.e., the previous process) exists (step S311). If a line above the target line exists (YES in step S311), the code conversion unit 40 sets the line one above as the target line (step S312) and repeats the processing from step S302 onward, reading one line of processing in the function Func.

On the other hand, if a line above the target line does not exist (NO in step S311), the code conversion unit 40 terminates the processing (conversion processing to a code to speed up the process) (step S320).

If, in step S303, the operation is not for g on both the right and left sides (NO in step S303), that is, if the operation is for a data frame df other than g, then step S401 and subsequent processing are performed as shown in FIG. 8.

Specifically, the code conversion unit 40 determines whether a data frame df other than g is generated by an equal sign filter by a key to be aggregated (groupkey) (step S401). If a data frame df other than g is generated (YES in step S401), the code conversion unit 40 converts the code of the target line to a code for speed-up (step S402).

On the other hand, if no data frame df other than g is generated (NO in step S401), the code conversion unit 40 determines whether or not the operation of the target line is an operation to overwrite by reference with the iloc property (i.e., the first operation) (step S403). If the operation of the target line is the first operation (YES in step S403), the code conversion unit 40 converts the code of the target line to a code for speed-up (step S404).

Similarly, if the operation of the target line is not the first operation (NO in step S403) and is an arithmetic operation (YES in step S405), the code conversion unit 40 converts the code of that target line to a code for speed-up (step S406). Furthermore, if the operation of the target line is not an arithmetic operation (NO in step S405), but an aggregation operation (YES in step S407), the code conversion unit 40 converts the code of the target line to a code for speed-up (step S408). If the operation of the target line is not an aggregation operation (NO in step S407), the code conversion unit 40 terminates the processing without converting the code. In the processing from step S403 to step S408, the order of the determination processing may be interchanged.

After the process of converting to the code for speed-up (i.e., after step S402, step S404, step S406, and step S408), the processing after step S311 in FIG. 7 is performed.

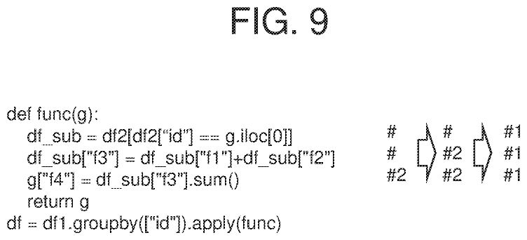

Here, specific program codes are used to explain the extraction processing and conversion processing shown by the flowcharts shown in FIGS. 5 through 8. FIG. 9 is an explanatory diagram showing an example of extraction processing and conversion processing.

First, the code extraction unit 30 determines whether the data frame to be returned (return) is identical to the input (i.e., argument) data frame. In the codes shown in FIG. 9, they are all the same data frame g.

Next, the code extraction unit 30 reads the bottom line (the third line of processing) and determines whether the operation in the target line is an operation on g on both the right and left sides. Here, since both the right and left sides are not operations on g, the code extraction unit 30 determines whether a data frame df other than g is generated by the equal sign filter by a key to be aggregated (groupkey).

Here, no data frame df other than g is generated, so the code extraction unit 30 determines whether the operation is a data referencing operation, an arithmetic operation, or an aggregation operation. Here, since it corresponds to an aggregation operation, flag #2 is set to the target line. Then, since the line above the target line (i.e., the previous operation) exists, the line (the second line of the operation) is read.

The code extraction unit 30 determines whether the operation of the target line is an operation on g on both the right and left sides. Here, since both the right and left sides are not operations on g, the code extraction unit 30 determines whether a data frame df other than g is generated by the equal sign filter by a key to be aggregated (groupkey). Here, since no data frame df other than g is generated, the code extraction unit 30 determines whether the operation is a data referencing operation, an arithmetic operation, or an aggregation operation. Here, since it corresponds to an arithmetic operation, flag #2 is set to the target line. Then, since the line above the target line (i.e., the previous operation) exists, the line (the first line of the operation) is read.

The code extraction unit 30 determines whether the operation of the target line is an operation on g on both the right and left sides. Here, since neither the right side nor the left side is an operation on g, the code extraction unit 30 determines whether a data frame df other than g is generated by the equal sign filter by a key to be aggregated (groupkey). Here, since a data frame df other than g is generated, the code extraction unit 30 sets flag #1 to the target line. Furthermore, the code extraction unit 30 replaces the flag of the line in which flag #2 is set with flag #1.

Then, since there is no line above the target line (i.e., the previous process), the code extraction unit 30 determines whether flag #1 is set for all lines. Here, since flag #1 is set for all lines, the code extraction unit 30 determines that speed-up is possible.

As described above, in this example embodiment, the input unit 20 accepts input of the target program code, and the code extraction unit 30 extracts the first program code and the second program code from the target program code. The code conversion unit 40 converts the extracted codes into an alternative program code, i.e., a program code that indicates a process that does not make function calls and that produces the same results as the process by the extracted code, and the output unit 50 outputs the alternative program code.

Therefore, existing codes can be converted into codes with same results so that processing time for data can be reduced. In other words, the time required for processing can be suppressed because the code conversion unit 40 changes the program code that makes function calls after the aggregation operation into a program code that does not make function calls.

The operation of the code conversion device of the present disclosure is described below using a specific example. As described above, the code extraction unit 30 extracts the first and second program codes from the target program code. In the following description, it is assumed that func(g) is a program code that indicates a predefined processing with a data frame as an argument. In this case, apply(func) and func(g) are examples of the second program code, which is a program code that indicates the predefined processing func performed on the data frame and the function apply that calls func.

As described above, groupby is an example of the first program code, which is a program code indicating that the aggregate processing of each column in the data frame is performed based on the values of the given columns. Therefore, in this specific example, the code extraction unit 30 extracts the program code that represents the content of groupby+apply(func).

Note that apply in pandas is a method that emphasizes convenience, and is a convenient method that allows programmers to intuitively describe the functions they want to implement. On the other hand, if the code is written in the form of groupby+apply(func), it is necessary to call func for the number of groups of aggregated data frames, which may slow down the calculation. On the other hand, the code conversion device of the present disclosure automatically detects such described codes and enables to convert them to codes to speed up the process.

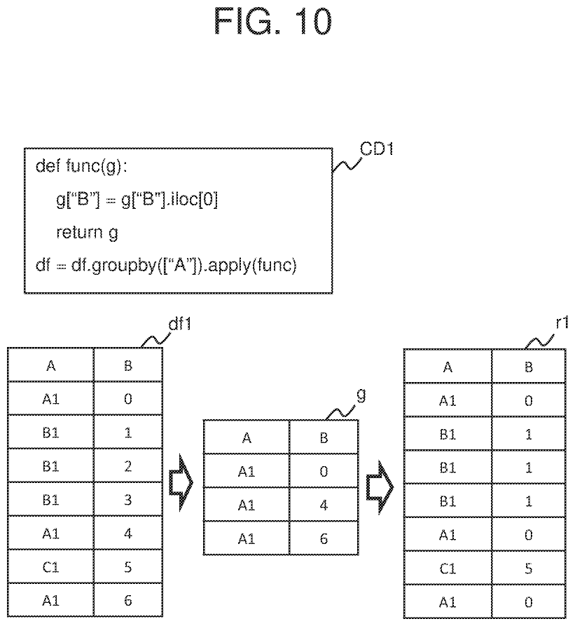

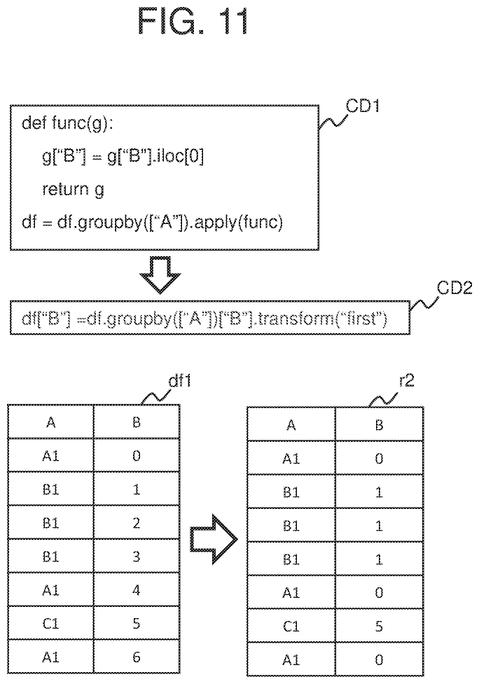

First, a first specific example of performing the conversion processing is described. FIGS. 10 and 11 are explanatory diagrams showing a first example of conversion processing. FIGS. 10 and 11 show the process of overwriting the values of column B in the group with the first values of other column B when grouped by the values of column A in data frame df1.

If the code is written in the form groupby+apply(func), this processing can be represented by the code CD1 shown in FIG. 10. First, when the data frame df1 is grouped by column A, for example, a data frame g is obtained in which the value A1 is aggregated. The same is true for the other values. The code CD1 indicates a process of calling the function func as many times as the number of aggregated data frames using this data frame g as an argument. As a result, data frame r1 is obtained.

In contrast, as shown in FIG. 11, the code CD1 shown in FIG. 10 can be converted to the code CD2 to speed up the processing. The code conversion unit 40 may, for example, generate the alternative program code, code CD2, based on the correspondence shown in the example in FIG. 3 (specifically, the second line of the table). As a result, a data frame r2 is obtained, the contents of which are the same as the contents of the data frame r1 shown in FIG. 10.

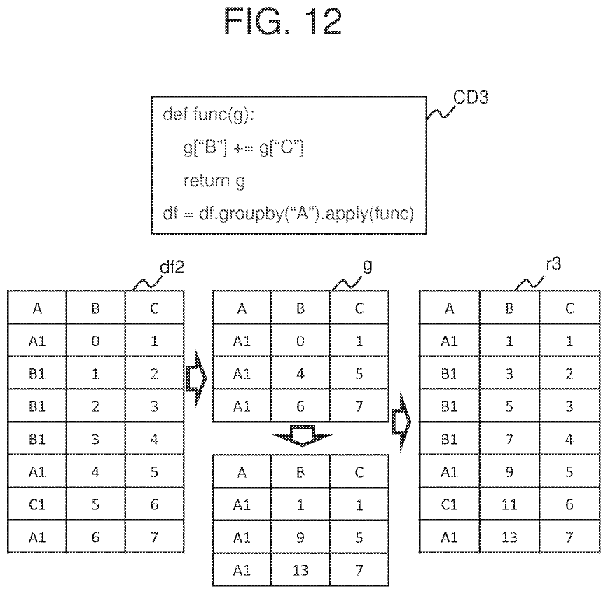

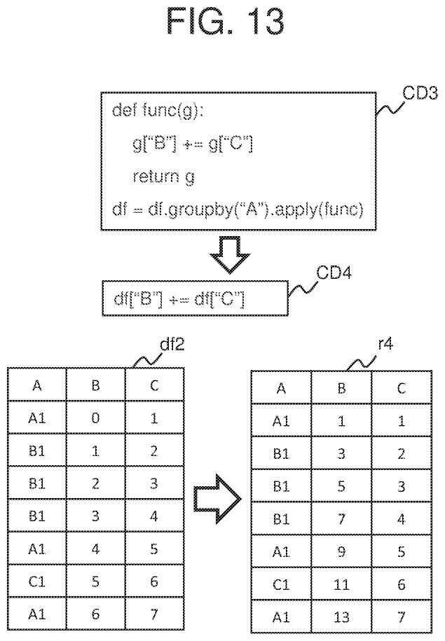

Next, a second specific example of performing the conversion processing is described. FIGS. 12 and 13 are explanatory diagram showing a second example of conversion processing. FIGS. 12 and 13 show the process of adding the values of other columns B and C when the data frame df2 is grouped by the values of column A.

If the code is written in the form groupby+apply(func), this processing can be represented by the code CD3 shown in FIG. 12. First, when the data frame df2 is grouped by column A, for example, a data frame g is obtained in which the value A1 is aggregated. The same is true for the other values. The code CD3 indicates a process of calling the function func as many times as the number of aggregated data frames using this data frame g as an argument. As a result, data frame r3 is obtained.

In contrast, as shown in FIG. 13, the code CD3 shown in FIG. 12 can be converted to code CD4 to speed up the processing. The code conversion unit 40 may, for example, generate the alternative program code, code CD4, based on the correspondence shown in the example in FIG. 3 (specifically, the third line of the table). As a result, a data frame r3 is obtained, the contents of which are the same as the contents of the data frame r3 shown in FIG. 12.

In this processing, the code conversion unit 40 may not update column B with the added values, but may create a new column D and set the added values in that column.

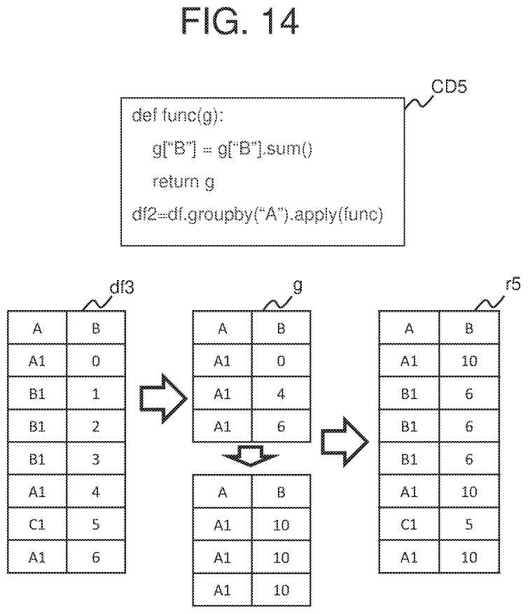

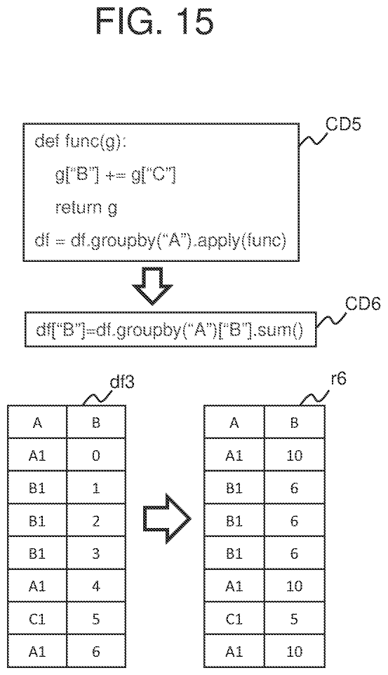

Next, a third specific example of performing the conversion processing is described. FIGS. 14 and 15 are explanatory diagrams showing a third example of conversion processing. FIGS. 14 and 15 show, when grouped by the values of column A in data frame df3, the process of calculating the sum of the values of the other columns B in the group.

If the code is written in the form groupby+apply(func), this processing can be represented by the code CD5 shown in FIG. 14. First, when the data frame df3 is grouped by column A, for example, a data frame g is obtained in which the value A1 is aggregated. T The same is true for the other values. The code CD5 indicates a process of calling the function func as many times as the number of aggregated data frames using this data frame g as an argument. As a result, data frame r5 is obtained.

In contrast, as shown in FIG. 15, the code CD5 shown in FIG. 14 can be converted to code CD6 to speed up the processing. The code conversion unit 40 may, for example, generate code CD6, an alternative program code, based on the correspondence shown in the example in FIG. 3 (specifically, the fourth line of the table). As a result, a data frame r6 is obtained, the contents of which are the same as the contents of the data frame r5 shown in FIG. 14.

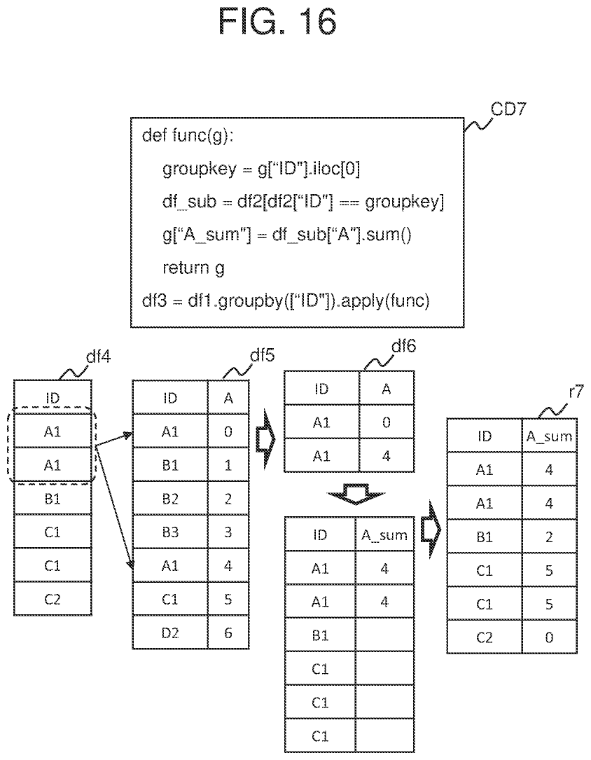

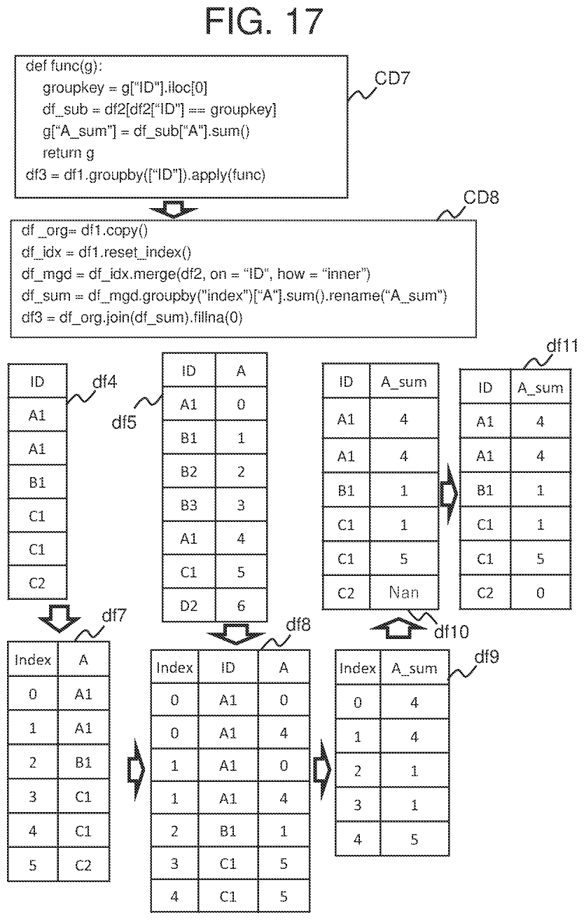

Next, a fourth specific example of performing the conversion processing is described. FIGS. 16 and 17 are explanatory diagram showing a fourth example of conversion processing. FIGS. 16 and 17 show the process of extracting data that matches the value in the ID column of data frame df4 from the ID column, which is a key (groupkey) to be aggregated in another data frame df5. The filter operation, which retrieves data equal to the groupkey from another data frame, can be regarded as a join operation. An example of such an operation is, for example, an operation to calculate statistical data from data frame df5, which stores a customer's past product purchase records, using the customer ID in data frame df4 as a key.

If the code is written in the form groupby+apply(func), this processing can be represented by the code CD7 shown in FIG. 16. The code CD7 indicates a process of calling the function func as many times as the number of aggregated data frames using data frames grouped by ID as arguments.

First, data frame df6 is obtained by grouping by column ID for data frame df4 and searching for lines corresponding to value A1, for example, from data frame df5. Then, the sum of the values in the obtained data frame df6 is calculated. The same is true for the other values. As a result, data frame r7 is obtained.

In contrast, as shown in FIG. 17, the code CD7 shown in FIG. 16 can be converted to code CD8 to speed up the process. The code conversion unit 40 may, for example, generate code CD8, an alternative program code, based on the correspondence shown in the example in FIG. 3 (specifically, the first line of the table). As a result, a data frame r11 is obtained, the contents of which are the same as the contents of the data frame r7 shown in FIG. 16.

The conversion processing in the fourth specific example is described in detail below. First, the code conversion unit 40 converts the target program code into a code that generates data frame df7 by copying data frame df4 and assigning an index to it for later use. Next, the code conversion unit 40 converts the target program code into a code that combines data frame df5 and data frame df7 by column ID to generate data frame d8.

In this specific example, for the column ID of data frame df7, the value A1 is associated with the topmost Index=0. For the entire data frame df5, there are multiple (two) lines where the value A1 is associated with the column ID. In this case, the line with Index=0 in data frame df7 is duplicated and combined.

Similarly for the other Indexes, lines with Index=1 are duplicated into two, and lines with Index=2 are duplicated into one. In addition, lines with Index=3 and Index=4 are duplicated by one, and lines with Index=5 are not duplicated. Here, copying the corresponding line of the data frame df5 multiple times when the column A matches corresponds to the operation of extracting the data frame df5 using a filter for the line with the matching key in apply(func).

The code conversion unit 40 converts the target program code into a code that calculates the sum by an aggregation process using the Index of the data frame d8 as a key and generates a data frame d9 indicating the calculated result. Then, the code conversion unit 40 converts the target program code into a code that combines the copied data frame df4 and data frame df9 to generate data frame df10. Considering the existence of missing values as shown in ID=C2, the code conversion unit 40 converts the target program code into a code that generates data frame df11 with the missing values filled with 0.

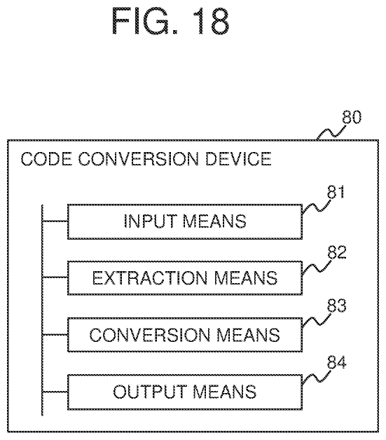

The following is an overview of the present disclosure. FIG. 18 is a block diagram showing an overview of the code conversion device according to the present disclosure. The code conversion device 80 (e.g., code conversion device 100) according to the present disclosure includes an input means 81 (e.g., input unit 20) which accepts input of a target program code which is the program code to be processed, an extraction means 82 (e.g., code extraction unit 30) which extracts, from the target program code, a first program code (e.g., groupby( ) method) indicating that aggregation processing of each column in a data frame is performed based on a predetermined column value for a data frame representing data in a two-dimensional tabular format, and a second program code (e.g., apply( ) method) indicating predefined processing to be performed on each data frame for which the aggregation processing is performed and a function that calls the predefined processing, a conversion means 83 (e.g., code conversion unit 40) which converts the extracted first program code and second program code into alternative program code, which is program code indicating a process that does not make a function call that invokes the predefined processing by the function and that produces a same result as the processing by the first program code and the second program code, and an output means 84 (e.g., output unit 50) which outputs the alternative program code.

Such a configuration allows existing codes to be converted into codes that produce same results so that data processing time can be reduced.

Specifically, the conversion means 83 may generates the alternative program code by converting a program code contained in the function indicated by the second program code into a corresponding predetermined program code (e.g., the correspondence table shown in FIG. 2).

The conversion means 83 may convert the first program code and the second program code into the alternative program code when a type of arguments used to call a processing and a type of a return value of the predefined processing match.

The conversion means 83 may convert a code indicated by a first operation, which is expressed by an expression linked by an equal sign among operations in predefined processing, into a code for speed-up the processing when both right and left sides of the expression are operations on the data frame to be the argument when invoking the processing, and when there is no possibility of changing the number of lines of the data frame to be the argument by the first operation.

The conversion means 83 may convert a code indicated by a first operation, which is expressed by an expression linked by an equal sign among operations in predefined processing, into a code for speed-up the processing when at least one of right and left sides of the expression is not an operation on the data frame to be the argument when invoking the processing.

The conversion means 83 may convert a code indicated by the operation expressed by the expression linked by an equal sign into a code for speed-up the processing when a data frame other than the data frame is generated by an equal sign filter by a key to be aggregated in the data frame to be the argument.

1. A code conversion device comprising:
a memory storing instructions; and
one or more processors configured to execute the instructions to:
accept input of a target program code which is the program code to be processed;
extract, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing;
convert the extracted first program code and second program code into alternative program code, which is program code indicating a process that does not make a function call that invokes the predefined processing by the function and that produces a same result as the processing by the first program code and the second program code; and
output the alternative program code.

2. The code conversion device according to claim 1, wherein the processor is configured to execute the instructions to
generate the alternative program code by converting a program code contained in the function indicated by the second program code into a corresponding predetermined program code.

3. The code conversion device according to claim 1, wherein the processor is configured to execute the instructions to
convert the first program code and the second program code into the alternative program code when a type of arguments used to call a processing and a type of a return value of the processing match.

4. The code conversion device according to claim 1, wherein the processor is configured to execute the instructions to
convert a code indicated by a first operation, which is expressed by an expression linked by an equal sign among operations in predefined processing, into a code for speed-up the processing when both right and left sides of the expression are operations on the data frame to be the argument when invoking the processing, and when there is no possibility of changing the number of lines of the data frame to be the argument by the first operation.

5. The code conversion device according to claim 1, wherein the processor is configured to execute the instructions to
convert a code indicated by a first operation, which is expressed by an expression linked by an equal sign among operations in predefined processing, into a code for speed-up the processing when at least one of right and left sides of the expression is not an operation on the data frame to be the argument when invoking the processing.

6. The code conversion device according to claim 5, wherein the processor is configured to execute the instructions to
convert a code indicated by the operation expressed by the expression linked by an equal sign into a code for speed-up the processing when a data frame other than the data frame is generated by an equal sign filter by a key to be aggregated in the data frame to be the argument.

7. A code conversion method comprising:
accepting input of a target program code which is the program code to be processed;
extracting, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing;
converting the extracted first program code and second program code into alternative program code, which is program code indicating a process that does not make a function call that invokes the predefined processing by the function and that produces a same result as the process by the first program code and the second program code; and
outputting the alternative program code.

8. The code conversion method according to claim 7, further comprising:
generating the alternative program code by converting a program code contained in the function indicated by the second program code into a corresponding predetermined program code.

9. A non-transitory computer readable information recording medium storing a code conversion program, when executed by a processor, that performs a method for:
accepting input of a target program code which is the program code to be processed;
extracting, from the target program code, a first program code indicating that aggregation processing of each column in a data frame is performed based on a predetermined column value for a data frame representing data in a two-dimensional tabular format, and a second program code indicating predefined processing to be performed on each data frame for which the aggregation processing is performed and a function that calls the predefined processing;
converting the extracted first program code and second program code into alternative program code, which is program code indicating a process that does not make a function call that invokes the predefined processing by the function and that produces a same result as the process by the first program code and the second program code; and
outputting the alternative program code.

10. The non-transitory computer readable information recording medium according to claim 9, wherein
the alternative program code is generated by converting a program code contained in the function indicated by the second program code into a corresponding predetermined program code.
